(19) United States
(12) Patent Application Publication
(10) Pub. No.: US 2016/0096753 A1
(43) Pub. Date: Apr. 7, 2016

(54) Long Term Dual Biocide and Hydrogen Sulfide Remediation

(71) Applicant: Trican Well Service, Ltd., Calgary (CA)

(72) Inventors: Sarkis R Kakadjian, The Woodlands, TX (US); Joseph Earl Thompson, Houston, TX (US); Jim Venditto, Houston, TX (US)

(73) Assignee: Trican Well Services, Ltd., Calgary (CA)

(21) Appl. No.: 14/508,009

(22) Filed: Oct. 7, 2014

(51) Int. Cl. C02F 1/68

(52) U.S. Cl. CPC C02F 1/68; C02F 2101/101

(57) ABSTRACT

In wellbore construction it has become environmentally and economically practical to treat flow back and produced water at the well site. Typically the flow back and produced water is initially contained in an open air pond. The water is then run to a treatment system to remove particulates and then deposited in a second clean pond. The water in the second clean pond may be allowed to sit in the pond for weeks before it is pumped out to be taken and disposed of or most likely to be used as a water source in the construction of a different well. Unfortunately even though the water may have initially been treated with the biocide due to the open environment to water is usually re-contaminated with both nutrients and both aerobic and anaerobic bacteria. The anaerobic bacteria usually include sulfur reducing bacteria which in turn produces hydrogen sulfide dissolved in the water. It has been found that an effective way to treat the clean pond to prevent contamination of the clean pond of sulfur reducing bacteria and its consequent hydrogen sulfide is to initially treat the second pond with a short-term or quick kill biocide as well as with the hydrogen sulfide scavenger that may then act as a long term biocide.

### BACKGROUND

Hydraulic fracturing is a common and well-known enhancement method for stimulating the production of hydrocarbon bearing formations. The process involves injecting fluid down a wellbore at high pressure. The fracturing fluid is typically a mixture of water and proppant. The proppant may be made of natural materials or synthetic materials.

Typically large amounts of water are required in a typical hydraulic fracturing operation and water is a limited resource therefore operators are searching for sources of water as well as means to dispose of contaminated water that may include flowback, produced, and other waters that have been used in well development. It is now becoming common to treat water used in well development, such as produced and flowback water.

An operator may pump produced water, flow back water, and frac fluids into a holding pond. The water that is pumped in to the holding pond is contaminated with many things which usually include anaerobic bacteria. As the anaerobic bacteria consume the nutrients in the pond it produces hydrogen sulfide gas.

The operator may then pump the water out of the holding pond and treat the water to remove particulates. The now relatively clean water is then pumped into a clean second holding pond. Unfortunately this water is usually allowed to sit in this second holding pond for several weeks before the water is then moved into a closed tank for removal from the site.

Hydrogen sulfide is corrosive in the presence of water and poisonous in very small concentrations and must be almost completely removed from water and air. It has been found that when the water is placed in the closed tank hydrogen sulfide gas, beyond safe limits, accumulates in the headspace in the closed tank. The unsafe accumulation of gas in the headspace occurs even though the hydrogen sulfide that is present in the liquid is well within safe limits.

It has been found that the hydrogen sulfide gas builds up in the water due to the presence of anaerobic bacteria, even though the water was clean and treated with a biocide as it was pumped into the clean second holding pond.

Upon investigation it is been found that some biocides, while effective, may only be effective for a short period of time. Typically, within hours of the water being moved into a clean second holding pond, the biocide is no longer effective and aerobic and anaerobic bacteria are reintroduced, either by external factors or by reproducing when the bacteria present are not one hundred percent eradicated. Once bacteria are present in sufficient quantities the aerobic bacteria begin to feed on the nutrients in the water using up the oxygen in the process. Anaerobic bacteria such as desulfovibrio bacteria, which are present in most water in oilfield operations, convert sulfate ions to hydrogen sulfide which may lead to reservoir souring. Hydrogen sulfide is acidic and in turn causes sulfide scaling, typically, iron sulfides. The hydrogen sulfide gas also causes environmental and health issues, particularly when the gas accumulates in enclosed spaces.

### SUMMARY

As envisioned in a current embodiment of the present invention, produced or flowback water is pumped into a clean open container, typically a holding pond, after an initial treatment to remove particulates. The water in the pond or other open air storage facility is then treated with a quick kill biocide, such as 2,2-dibromo-3-nitrilopropionamidemay to kill any bacteria present when the water is treated. However, such a biocide is typically neutralized within a few hours of treatment. Additionally, a hydrogen sulfide scavenger is added to the water at about the same time as the biocide is added. The hydrogen sulfide scavenger may be a hydrogen sulfide scavenger such as triazine which is added in an amount sufficient to reduce all of the hydrogen sulfide present in the water. An excess amount of the hydrogen sulfide scavenger is also added where the additional amount of the hydrogen sulfide scavenger continues to work as a biocide on the anaerobic sulphur reducing bacteria for several weeks after treatment.

In one embodiment the quick kill biocide, the hydrogen sulfide scavenger, and the excess hydrogen sulfide scavenger are metered into the water in the clean pond as the water is pumped out of the particulate treatment. The quick kill biocide, the hydrogen sulfide scavenger, and the excess hydrogen sulfide scavenger may also be added to the water during its treatment to remove particulates or may be added to the clean pond after the water has been treated to remove particulates.

### BRIEF DESCRIPTION OF THE DRAWINGS

FIG. 1 is a picture of several test vials having samples of water that were treated with various biocides where the water generates >200 ppm of hydrogen sulfide in the head space as well as sulfate reducing bacteria that was initially treated with 0.1 gallons per thousand (GPT) of a hydrogen sulfide scavenger.

FIG. 2 is a picture of several test vials having samples of water that were treated with various biocides where the water generates 30 ppm of hydrogen sulfide in the head space as well as sulfate reducing bacteria that was initially treated with 0.2 gallons per thousand (GPT) of a hydrogen sulfide scavenger.

FIG. 3 is a picture of several test vials having samples of water that were treated with various biocides where the water generates 0 ppm of hydrogen sulfide in the head space as well as sulfate reducing bacteria that was initially treated with 0.5 gallons per thousand (GPT) of a hydrogen sulfide scavenger.

FIG. 4 is a picture of several test vials having samples of water that were treated with various biocides where the water has high levels of sulfate reducing bacteria.

### DETAILED DESCRIPTION

The description that follows includes exemplary apparatus, methods, techniques, or instruction sequences that embody techniques of the inventive subject matter. However, it is understood that the described embodiments may be practiced without these specific details.

Presently preferred hydrogen sulfide scavengers to act as both a hydrogen sulfide scavenger and as a long term biocide include, but are not limited to triazine based material having about 30% to 60% alkanolamine/aldehyde condensate, 5% to 10% methanol, and 1% to 5% of monoethanolamine.

Generally useful hydrogen sulfide scavengers to act as both a hydrogen sulfide scavenger and as a long term biocide include, but are not limited to, alkanolamines such as monoethanolamine, diethanolamine, N-methyldiethanolamine, and diglycolamine. Other hydrogen sulfide scavengers include but are not limited to triethanolamine, diisopropanolamine, 2-amino-2-methyl-1-propanol, polyethylene glycol, N-methyl pyrrolidone, propylene carbonate, methanol, potassium carbonate, sulfolane, triazine, triazinine, meric amidines, maleimides, azodicarbonamides; dimethylsulfates, diethylsulfates, nitrites, bicarbonates, carbonates, hydroxides, alkoxides, or the like, or mixtures or combinations thereof, including but not limited to ethylenediaminetetraacetic acid and hydroxyethylethylenediaminetriacetic acid; ferric chelates such as N-(2-hydroxyethyl); zinc chelates such as zinc carboxylate; piperazinone alkyl substituted derivatives such as 1,4-dimethylpiperazinone; benzoquinones such as para-benzoquinone; and nitrate solutions.

Presently the preferred short term or quick kill biocide is 2,2-Dibromo-3-nitrilopropionamide. Other useful biocides include, but are not limited to calcium hypochlorite, aldehydes, quaternary phosphonium compounds, quaternary ammonium compounds, cationic polymers, organic bromides, metronidazole, isothiazolones, isothiazolinones, thiones, organic thiocyanates, phenolics, alkylamines, diamines, triamines, dithiocarbamates, and 2-(decylthio)ethanamine and its hydrochloride, hypochlorite and hypobromite and their salts, stabilized bromine chloride, chlorine dioxide, chloroisocaynurates, halogen containing hydantoins, hydrogen peroxide, and peracetic acid.

Each of the tests depicted below are conducted in tubes of culture media that is specifically formulated to promote the growth of anaerobic sulfate reducing bacteria. The medium contains reducing agents that maintain a low oxidation reduction potential and thus allows for maximum growth. When the anaerobic sulfate reducing bacteria grow in this medium, sulfate is reduced to sulfide and a black precipitate of iron sulfide is formed. The degree of blackening through the medium is directly proportional to the amount of sulfate reducer growth. Table 1 below gives the numbers of sulfate reducing bacteria by appearance based upon the number of days that the test sample has incubated.

TABLE 1

| | Days of incubation | | | | |
|---|---|---|---|---|---|
| | 1 | 2 | 3 | 4 | 5 |
| Completely black | ≧10⁶ | 10⁶-10⁵ | 10⁵-10⁴ | 10⁴-10³ | 10³-10² |
| Partially black | 10⁶-10⁵ | 10⁵-10⁴ | 10⁴-10³ | 10³-10² | 10²-10¹ |
| No Reaction | <10⁵ | <10⁴ | <10³ | <10² | <10¹ |

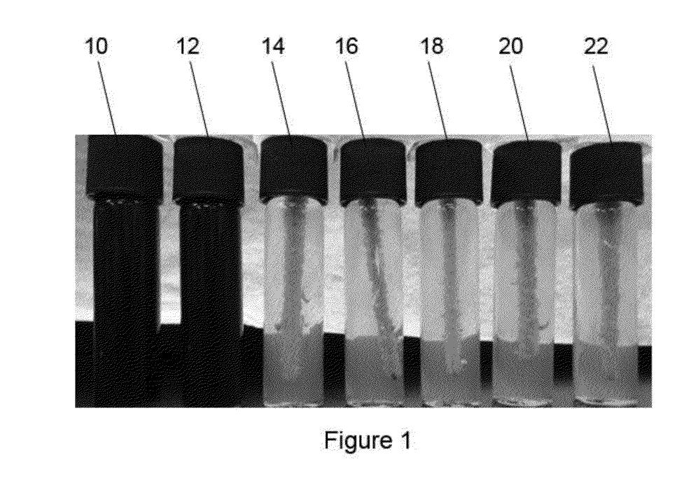

FIG. 1 depicts several test vials each having a sample of water that generates >200 ppm of hydrogen sulfide in the overhead space as well as being contaminated with sulfate reducing bacteria were treated with 0.1 gallons per thousand (GPT) of a of a hydrogen sulfide scavenger triazine based material having about 30% to 60% alkanolamine/aldehyde condensate, 5% to 10% methanol, and 1% to 5% of monoethanolamine.

The mixture was then allowed to sit for 24 hours. The mixture was then placed in test vials before additional biocide was added. Each test vial was then allowed to sit for six days during which the test vials were inspected to determine the amount of sulfate reducing bacteria present in each vial. Test vial 10 was not treated with a short term biocide and is used as a baseline. Test vial 10 turned black after 4 days indicating that there were between about 10⁴-10³ sulfate reducing bacteria per mL present in test vial 10 after incubating for 4 days. Test vial 12 was treated with 0.75 GPT of a 5% solution of 2,2-dibromo-3-nitrilopropionamide as a short term biocide. Test vial 12 also turned black after 4 days indicating that there were between about 10⁴-10³ sulfate reducing bacteria per mL present in test vial 12 after 4 days. Test vial 14 was treated with 0.75 GPT of a 5% solution of 2,2-dibromo-3-nitrilopropionamide and 0.2 GPT of a 50% solution of tetrakis-hydroxymethylphosphonium sulfate as short term biocides. Test vial 14 did not change its color and remained clear indicating that there were between about less than 10 sulfate reducing bacteria per mL present in test vial 14 after 6 days. Test vial 16 was treated with 0.75 GPT of a 5% solution of 2,2-dibromo-3-nitrilopropionamide and 0.4 GPT of a 25% solution of glutaraldehyde as short term biocides. Test vial 16 did not change its color and remained clear indicating that there were between about less than 10 sulfate reducing bacteria per mL present in test vial 16 after 6 days. Test vial 18 was treated with 0.75 GPT of 50% solution of didecyl-dimethyl ammonium chloride and 0.2 GPT of 50% solution of tetrakis-hydroxymethylphosphonium sulfate as short term biocides. Test vial 18 did not change its color and remained clear indicating that there were between about less than 10 sulfate reducing bacteria per mL present in test vial 18 after 6 days. Test vial 20 was treated with 0.75 GPT of a 5% solution of 2,2-dibromo-3-nitrilopropionamide and 0.4 GPT of a solution of 27% solution glutaraldehyde and 5% solution of benzyl quat as short term biocides. Test vial 20 did not change its color and remained clear indicating that there were between about less than 10 sulfate reducing bacteria per mL present in test vial 20 after 6 days. Test vial 22 was treated with 0.4 GPT of a solution of 27% glutaraldehyde and 5% benzyl quat as a short term biocide. Test vial 22 did not change its color and remained clear indicating that there were between about less than 10 sulfate reducing bacteria per mL present in test vial 22 after 6 days.

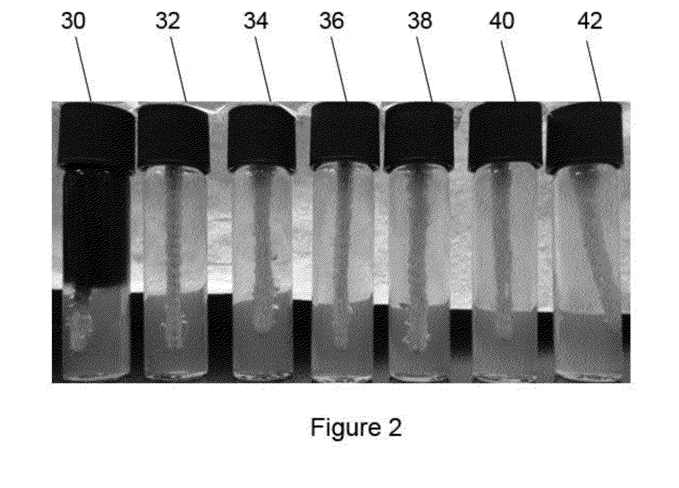

FIG. 2 depicts several test vials each having a sample of water that generates >30 ppm of hydrogen sulfide in the overhead space and is contaminated with a sulfate reducing bacteria after having been treated with 0.2 gallons per thousand (GPT) of a of a hydrogen sulfide scavenger triazine based mixture having about 30% to 60% alkanolamine/aldehyde condensate, 5% to 10% methanol, and 1% to 5% of monoethanolamine. The mixture was then placed in test vials previous additional biocide was added. Each test vial was then allowed to sit for six days during which the test vials were inspected to determine the amount of sulfate reducing bacteria present in each vial. Test vial 30 was not treated with a short term biocide and is used as a baseline. Test vial 30 turned half black after 4 days indicating that there were between about 10³-10² sulfate reducing bacteria per mL present in test vial 30 after incubating for 4 days. Test vial 32 was treated with 0.75 GPT of a 5% solution of 2,2-dibromo-3-nitrilopropionamide as a short term biocide. Test vial 32 did not change its color and remained clear indicating that there were less than 10 sulfate reducing bacteria per mL present in test vial 32 after 6 days. Test vial 34 was treated with 0.75 GPT of a 5% solution of 2,2-dibromo-3-nitrilopropionamide and 0.2 GPT of 50% solution of tetrakis-hydroxymethylphosphonium sulfate as short term biocides. Test vial 34 did not change its color and remained clear indicating that there were between about less than 10 sulfate reducing bacteria per mL present in test vial 34 after 6 days. Test vial 36 was treated with 0.75 GPT of a 5% solution of 2,2-dibromo-3-nitrilopropionamide and 0.4 GPT of 25% solution of glutaraldehyde as short term biocides. Test vial 36 did not change its color and remained clear indicating that there were between about less than 10 sulfate reducing bacteria per mL present in test vial 36 after 6 days. Test vial 38 was treated with 0.75 GPT of a 50% solution of didecyl-dimethyl ammonium chloride and 0.2 GPT of a 50% solution of tetrakis-hydroxymethylphosphonium sulfate as short term biocides. Test vial 38 did not change its color and remained clear indicating that there were between about less than 10 sulfate reducing bacteria per mL present in test vial 38 after 6 days. Test vial 40 was treated with 0.75 GPT of a 5% solution of 2,2-dibromo-3-nitrilopropionamide and 0.4 GPT of a solution of 27% glutaraldehyde and 5% solution of benzyl quat as short term biocides. Test vial 40 did not change its color and remained clear indicating that there were between about less than 10 sulfate reducing bacteria per mL present in test vial 40 after 6 days. Test vial 42 was treated with 0.4 GPT of a solution of 27% glutaraldehyde and 5% solution of benzyl quat as a short term biocide. Test vial 42 did not change its color and remained clear indicating that there were between about less than 10 sulfate reducing bacteria per mL present in test vial 42 after 6 days.

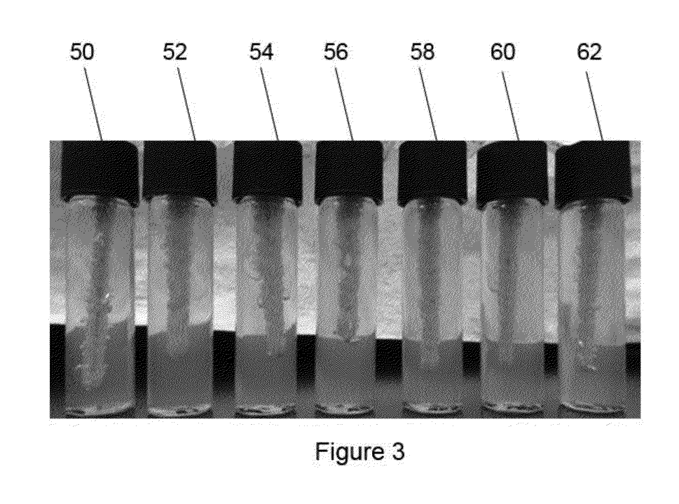

FIG. 3 depicts several test vials each having a sample of water where the accumulation of hydrogen sulfide in the overhead space is 0.0 PPM as well as being contaminated with a sulfate reducing bacteria after treated with 0.5 gallons per thousand (GPT) of a of a hydrogen sulfide scavenger triazine based material having about 30% to 60% alkanolamine/aldehyde condensate, 5% to 10% methanol, and 1% to 5% of monoethanolamine. The mixture was allowed to sit for 24 hours. The mixture was then placed in test vials and an additional biocide was added. Each test vial was then allowed to sit for six days during which the test vials were inspected to determine the amount of sulfate reducing bacteria present in each vial. Test vial 50 was not treated with a short term biocide and is used as a baseline. Test vial 50 did not change its color and remained clear indicating that there were between about less than 10 sulfate reducing bacteria per mL present in test vial 50 after 6 days. Test vial 52 was treated with 0.75 GPT of a 5% solution of 2,2-dibromo-3-nitrilopropionamide as a short term biocide. Test vial 52 did not change its color and remained clear indicating that there were less than 10 sulfate reducing bacteria per mL present in test vial 52 after 6 days. Test vial 54 was treated with 0.75 GPT of a 5% solution of 2,2-dibromo-3-nitrilopropionamide and 0.2 GPT of tetrakis-hydroxymethylphosphonium sulfate as short term biocides. Test vial 54 did not change its color and remained clear indicating that there were between about less than 10 sulfate reducing bacteria per mL present in test vial 54 after 6 days. Test vial 56 was treated with 0.75 GPT of a 5% solution of 2,2-dibromo-3-nitrilopropionamide and 0.4 GPT of 25% solution glutaraldehyde as short term biocides. Test vial 56 did not change its color and remained clear indicating that there were between about less than 10 sulfate reducing bacteria per mL present in test vial 56 after 6 days. Test vial 58 was treated with 0.75 GPT of 50% solution of didecyl-dimethyl ammonium chloride and 0.2 GPT of 50% solution of tetrakis-hydroxymethylphosphonium sulfate as short term biocides. Test vial 58 did not change its color and remained clear indicating that there were between about less than 10 sulfate reducing bacteria per mL present in test vial 58 after 6 days. Test vial 60 was treated with 0.75 GPT of a 5% solution of 2,2-dibromo-3-nitrilopropionamide and 0.4 GPT of a solution of 27% glutaraldehyde solution and 5% benzyl quat solution as short term biocides. Test vial 60 did not change its color and remained clear indicating that there were between about less than 10 sulfate reducing bacteria per mL present in test vial 60 after 6 days. Test vial 62 was treated with 0.4 GPT of a solution of 27% glutaraldehyde and 5% benzyl quat as a short term biocide. Test vial 62 did not change its color and remained clear indicating that there were between about less than 10 sulfate reducing bacteria per mL present in test vial 62 after 6 days.

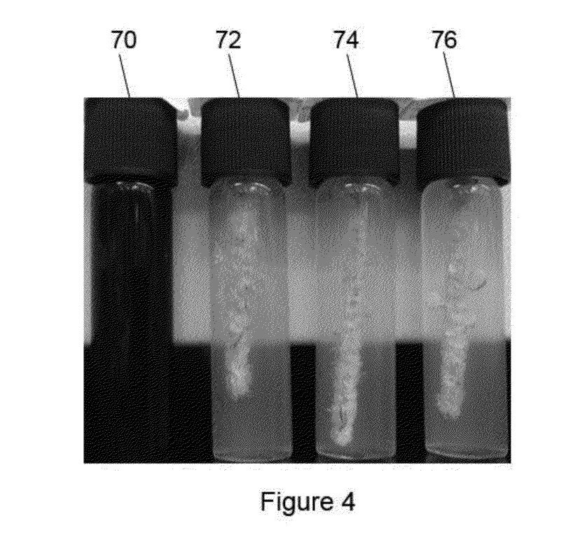

FIG. 4 depicts a several test vials with flowback water in each of the test vials. Test vial 70 was not treated and is used as a baseline. Test vial 70 turned black after 4 days indicating that there were between about 10⁴-10³ sulfate reducing bacteria per mL present in test vial 70 after 4 days. Test vial 72 was treated with 0.2 GPT of a 25% solution of hydrogen peroxide solution as a short term biocide and 0.2 GPT of hydrogen sulfide scavenger triazine based material having about 30% to 60% alkanolamine/aldehyde condensate, 5% to 10% methanol, and 1% to 5% of monoethanolamine and 0.2 GPT of 12.5% sodium hypochlorite as short term biocide. Test vial 72 did not change its color and remained clear indicating that there were less than 10 sulfate reducing bacteria per mL present in test vial 72 after 6 days. Test vial 74 was treated with 0.2 GPT of 25% solution of hydrogen peroxide as a short term biocide and 0.2 GPT of hydrogen sulfide scavenger triazine based material having about 30% to 60% alkanolamine/aldehyde condensate, 5% to 10% methanol, and 1% to 5% of monoethanolamine and 0.5 GPT of 12.% solution of sodium hypochlorite as a short term biocide. Test vial 74 did not change its color and remained clear indicating that there were less than 10 sulfate reducing bacteria per mL present in test vial 74 after 6 days. Test vial 76 was treated with 0.2 GPT of 25% solution of hydrogen peroxide as short term biocide and 0.2 GPT of hydrogen sulfide scavenger triazine based material having about 30% to 60% alkanolamine/aldehyde condensate, 5% to 10% methanol, and 1% to 5% of monoethanolamine and 1.0 GPT of 12.5% solution of sodium hypochlorite as a long term biocide. Test vial 76 did not change its color and remained clear indicating that there were less than 10 sulfate reducing bacteria per mL present in test vial 76 after 6 days.

This list of additives is not exhaustive and additional additives known to those skilled in the art that are not specifically cited above fall within the scope of the invention

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method of treating water comprising:
treating water to remove suspended solids,
moving the treated water into an open container,
adding a quick kill biocide to the treated water and,
adding a hydrogen sulfide scavenger in an amount sufficient to act also as a long term biocide.

2. The method of claim 1 wherein, the open container is a pond.

3. The method of claim 1 wherein, the hydrogen sulfide scavenger includes but is not limited to, an alkanolamines such as monoethanolamine, a diethanolamine, a N-methyldiethanolamine, diglycolamine, a triethanolamine, a diisopropanolamine, a 2-amino-2-methyl-1-propanol, a polyethylene glycol, a N-methyl pyrrolidone, a propylene carbonate, a methanol, a potassium carbonate, a sulfolane, a triazine, a triazinine, a meric an amidine, a maleimide, an azodicarbonamide; a dimethylsulfate, a diethylsulfate, a nitrite, a ferric chelate such as N-(2-hydroxyethyl); a zinc chelate such as zinc carboxylate; a piperazinone alkyl substituted derivative such as 1,4-dimethylpiperazinone; a benzoquinone such as para-benzoquinone; or a nitrate solutions

4. The method of claim 1 wherein, the quick kill biocide includes but is not limited to an aldehyde, a quaternary phosphonium compound, a quaternary ammonium surfactant, a cationic polymer, an organic bromide, an isothiazolone and thiones, an organic thiocyanate, an alkylamine, a diamine, a triamine, a dithiocarbamate, a 2-decylthioethanamine and its hydrochloride, a hypochlorite and its salts, a hypobromite and its salts, a stabilized bromine chloride, a chlorine dioxide, a chloroisocyanurate, a halogen-containing hydantoin, a hydrogen peroxide, or a peracetic acid.

5. The method of claim 1 wherein, the quick kill biocide is a 2,2-dibromo-3-nitrilopropionamide.

6. The method of claim 1 wherein, the hydrogen sulfide scavenger is a triazine based material.

7. The method of claim 1 wherein, the treated water is moved into an open container through a conduit.

8. The method of claim 7 wherein, the conduit is pre-treated with a chlorite or hypochlorite salts.
